(19) United States
(12) Patent Application Publication
(10) Pub. No.: US 2015/0221243 A1
(43) Pub. Date: Aug. 6, 2015

(54) Personalizing Tag For Individual Used Carrying Bag And Method Of Using The Same

(71) Applicant: Patrick French, New York, NY (US)

(72) Inventor: Patrick French, New York, NY (US)

(21) Appl. No.: 14/170,600

(22) Filed: Feb. 1, 2014

(51) Int. Cl. G09F 3/08; G09F 21/02

(52) U.S. Cl. CPC G09F 3/08; G09F 21/026

(57) ABSTRACT

A personalization tag kit is used to replace a handbag's original brand logo tag. Instead of plain old brand logo on the bag, this personalization tag may display statements such as bag owner's name, initials, or other styled characters that make the bag more personal or stylish to him or her.

### BACKGROUND OF THE INVENTION

1. Field of the Invention

The present invention relates to an accessory to consumer carrying bags, more particularly, to a decorative tag with personalized statements that can be attached to handbag, backpack or luggage in place of its original brand tag.

2. Description of Related Art

For most of consumers who purchase a new handbag, backpack or even a stylish luggage bag, usually the bag comes with its brand logo plate or tag. It could be a funky and modern style or a classic that never goes out of style. It is always bears its own brand name such as “Davey's” or “Coach”.

Cool enough on its own, however if some of the consumers want to make an individual statement, or make it even more stylish and uniquely individual, there is no way for them to do so.

Therefore, a customized, personalized tag is desirable for customers who want to be creative in making the bag more personal and unique to them.

### SUMMARY OF THE INVENTION

In an exemplary embodiment of the present invention, there is disclosed a tag kit which can be used to replace a handbag's original brand logo tag. Instead of plain old brand logo on the bag, this personalization tag may have statements such as bag owner's name, initials, or other styled characters that make the bag more personal or stylish to him or her.

Said personalization tag kit includes a tag that is constructed according to bags' original shape, size, or even materials if so desired, so that it maintains original esthetical design after replacing the brand logo. And means to attach said tag to the bags in lieu of its original brand logo tag. This tag kit may enable bag owner to personalize his or her own bags. The bag may be one of any following kinds, such as: satchel, tote, wallet, wristlet, hobo, cross-body bag, shoulder bag, shopper, backpack, or even luggage bag.

In one form of embodiment of present invention, said tag is made out of brass, stainless steel, plastic, leather or other common materials available or desirable in the market. Bag owner's name, initials, or other desirable information may be engraved or printed onto the tag's display surface. Said means to replace the original brand logo tag with this innovative personalization tag can be one of a flat head screw driver, wrench, other applicable household tools, or custom made tools designed for specific brand at service.

As one feature of present invention, the bag manufacturer may involve the bag owner to be part of the design process and customize the logo tag.

In another feature of present invention, the personalization tag kit may be sold along with bag in malls, specialty or franchise stores. Store may keep a machine which prints or engraves bag owner's name, initials, or other statement desirable onto the tag and then replace the original brand tag with it.

In still another feature of present invention, bag owner may perform such customizing design process later through various sources that provide said personalizing or customizing services. For example, said tag kit may be sold separately to bag owner via internet commerce and customize a bag with simple clicks on webpage. Bag owners provide basic information regarding what statement would be present on the logo tag, such as owner's name, initials, high school names, or simply a reminder that you only live once. The custom prepared tag kit will be shipped or delivered directly to the bag owner's intended address. And then the bag owner may replace the plate by themselves according to the operation specification included in the kit.

In one embodiment of present invention, to replace original brand tag with present invention, first locate the bag's original brand logo patch, then use a flathead screwdriver from the kit, loosen the screws until the original brand logo tag fall off. Take the personalized tag from the kit; align holes in the back side of the tag with the screws. Tighten the screws with small flat head screwdriver to ensure that said personalized tag is securely attached to the bag and cover the original place of brand logo tag.

Most of the time, the personalization tag is manufactured as of the same size and quality as the original logo tag. The means to attach said personalization tag onto the bag may be specially made for specified bag brand, or commonly used household tool such as screwdrivers. Said tools can be used to detach the original brand logo tag from the bag.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a front view of a handbag with its original brand logo tag attached;

FIG. 2 is a front view of the personalization tag of present invention with bag owner's name initials on its front surface;

FIG. 2a is a cross section view of assembly portion of the tag according to present invention;

FIG. 3 is a back view of the personalization tag of present invention;

FIG. 3a is a cross section view of assembly portion of the tag according to present invention.

### DESCRIPTION OF THE PREFERRED EMBODIMENT

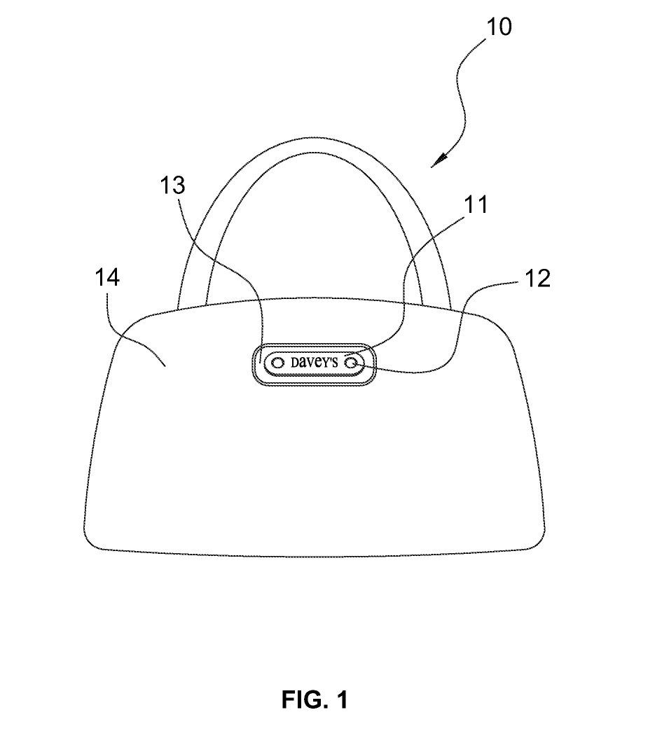

Referring to FIG. 1, there is disclosed an exemplary embodiment of present invention, a handbag 10 which is branded as “Davey's” is used for purposes of illustration. Only a portion of the handbag 10 with brand tag is shown. On one side of handbag, an original brand tag 11 with engraved English characters-“Davey's” is esthetically placed on its outside surface using two male/female screws 12. To protect the handbag surface material from possible erosion by direct contact with the tag, there is a buffer layer 13 placed between the tag and the major handbag wall 14. The original brand logo tag 11 is placed on top center of the buffer layer 13.

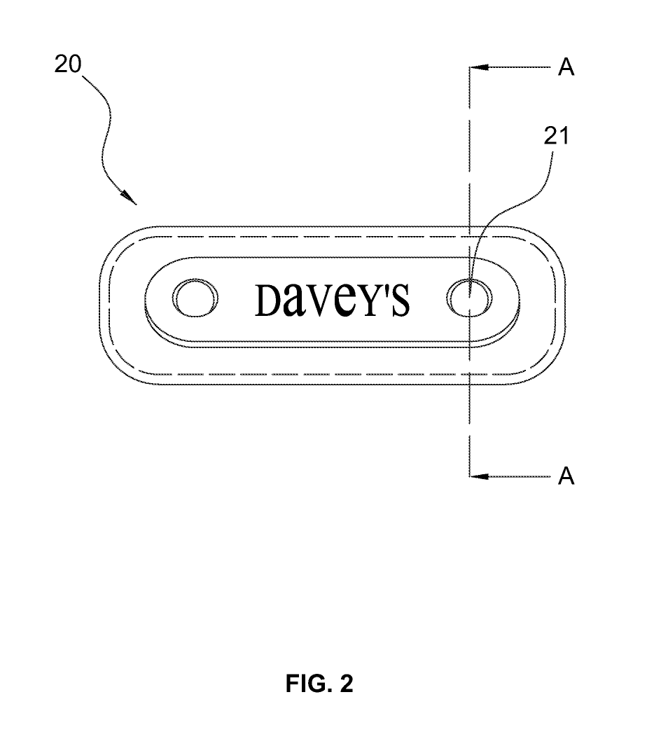

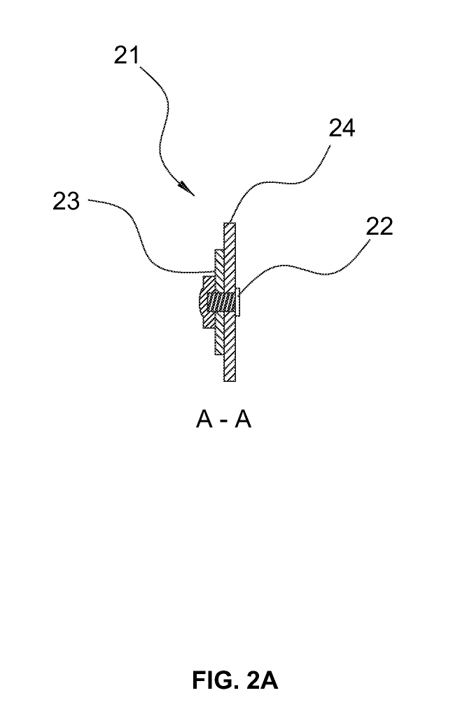

Referring to FIG. 2, the personalization tag 20 has a display portion to display personal statements configured by bag owner. Assuming that the bag owner wants her name initial “D.S.L.” on the tag instead of the brand name “Davey's”, and she wants all letters to be engraved onto the new replacement tag. She may select the fonts, color, style, and material of her new tag via service provider's website. She may also do so by calling the service phone number or at the store site where the personalization kit of present invention is provided. When she gets her personalization tag kit, the replacement tag is already engraved with her name initials “D.S.L.” on the display portion of the tag 20. Said tag 20 may be made out of brass or other materials available according to her choice.

Referring to FIG. 2 and FIG. 2a, the personalization tag 20 is configured with assembly portion 21. FIG. 2a shows the cross sectional view of said assembly portion 21 along the line A-A. As seen in FIG. 2a, flat head screw 22 is used to attach the personalization tag 20, buffer layer 23, handbag outside wall 24 and interior fabric layer (not shown) together so that the tag 20 is securely and esthetically fixed to the outside wall of the handbag 10.

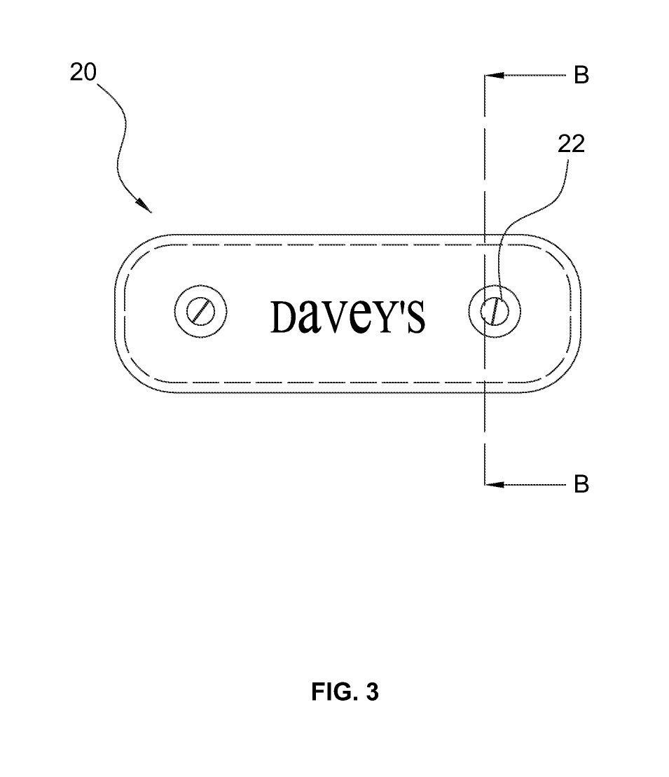

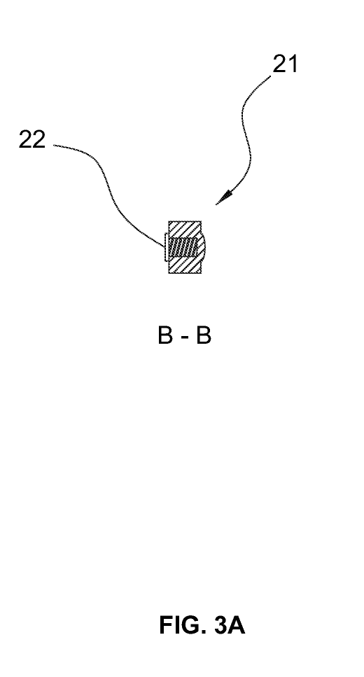

FIG. 3 shows the backside of personalization tag 20 where the screw head 22 of assembly portion 21 can be seen. FIG. 3a shows the cross section view along the line B-B of the assembly portion 21. The screw head 22 is securely locked into the tag without attaching to the handbag.

Certain steps may be followed to replace the handbag's logo with the personalization tag 20 of present invention. First locate the handbag's original brand logo tag 11 in FIG. 1, which shows its brand name “Davey's”. Use a screwdriver to loosen the screws until the original brand logo tag is fully removable. The screwdriver may be included in the tag kit for bag owner's convenience. Take the personalized tag 20 in FIG. 2 provided by the kit; place the tag 20 on top of the buffer layer 13 in FIG. 1; align holes in the back side of the tag with the screws. Tighten the screws with the screwdriver to ensure that said personalization tag 20 is securely attached to the bag and esthetically placed at the original place where the original logo tag is located.

The tool for attaching said personalization tag 20 is included in the kit for bag owner's convenience. The tool for removing the original brand logo tag 11 is also used for attaching said personalization tag 20. If needed, the tool for removing the original brand logo tag 11 may be custom made for brand at service.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A personalization tag kit for individual used carrying bags comprising:
a tag which has display portion for printed or engraved personalizing information desired by the bag owner; and
a assembly portion for attaching said tag to outside wall of the bag.

2. The personalization tag kit of claim 1, further comprising:
means to dissemble the original brand logo tag and to assemble said personalized tag, which is one of the screw driver, wrench or other commonly used house tools.

3. The personalization tag kit of claim 1, wherein the materials used for manufacturing said tag is brass.

4. The personalization tag kit of claim 1, wherein the material used for manufacturing said tag is selected from stainless steel, plastic, leather, or other desirable materials in the market.

5. The personalization tag kit of claim 1 or 2, wherein the size and shape of said tag is the same as the original brand logo tag so that it maintains original esthetical design after replacing the brand logo.

6. The personalization tag kit of claim 1 or 2, wherein said personalization tag is custom made to replace the brand logo tag for handbag brand “Davey's”.

7. The personalization tag kit of claim 1 or 2, wherein said display portion of said tag displays one of the bag owner initials, full name, last name, or any statements desired by the owner of the bag.

8. The personalization tag kit of claim 7, wherein the bag owner has choices as to combination of the content, fonts, styles and arrangement of the statement.

9. A method of using personalization tag kit for individual used carrying bags, comprising the steps of
Removing the original brand logo tag from the individual carrying bag;
Placing a personalization tag on top of the bag's outside wall where the original brand logo tag is located;
Securely attaching said personalization tag to the outside wall of the bag.

10. The method of using personalization tag kit of claim 9, wherein the tool for attaching said personalization tag is included in said kit.

11. The method of using personalization tag kit of claim 9, wherein the tool for removing the original brand logo tag is also used for attaching said personalization tag.

12. The method of using personalization tag kit of claim 9, wherein the tool for removing the original brand logo tag is custom made for brand at service.
